(19) United States
(12) Patent Application Publication
(10) Pub. No.: US 2016/0081024 A1
(43) Pub. Date: Mar. 17, 2016

(54) COOPERATIVE MAC PROTOCOL WITH RELAY SELECTION AND POWER CONTROL

(71) Applicant: SABANCI ÜNIVERSITESI, Istanbul (TR)

(72) Inventors: Muharrem Sarper GÖKTÜRK, Istanbul (TR); Özgür GÜRBÜZ, Istanbul (TR); Murat ERMAN, Istanbul (TR)

(73) Assignee: SABANCI ÜNIVERSITESI, Istanbul (TR)

(21) Appl. No.: 14/889,857

(22) PCT Filed: May 8, 2013
(86) PCT No.: PCT/EP2013/059639

§ 371 Date: Nov. 8, 2015

(51) Int. Cl. H04W 52/02; H04W 40/08; H04B 7/02

(52) U.S. Cl. CPC H04W 52/0219; H04B 7/026; H04W 40/08

(57) ABSTRACT

The present invention proposes a method of communication in a wireless relay network for finding group of relays that minimizes total energy consumption to send one successful bit to destination node, under reliability condition expressed in terms of average BER level, said method comprising three main phases in the manner that a reservation stage where cooperative data transmission request is made by the source node, an ACO epoch, where the announcements of the candidate relays are sent, the cooperation set is formed and power levels are assigned, and the cooperative data transmission stage itself, are defined.

### TECHNICAL FIELD OF THE INVENTION

The present invention relates to wireless networks wherein a more energy-efficient architecture is used and the hardware limitations and the power consumption cost of the wireless nodes are optimized.

### BACKGROUND OF THE INVENTION

Wireless communications is the fastest growing branch of the communication industry, as it enables mobile communication, reduces the required infrastructure, and thus reduces the deployment costs, and allows for easily expandable networks. With the recent advances in communication technologies, signal processing and hardware design, wireless networks have become ubiquitous. Unfortunately, the advantages of the wireless networks come together with challenges. The major challenge is the nature of the wireless medium itself, which is a shared and unpredictable channel with limited capacity. The wireless medium also suffers from channel impairments, such as path loss, shadowing and fading, which diminish the reliability of communication. Moreover, the wireless nodes have to communicate over the same medium, requiring efficient methods for wireless transmission, i.e., modulation and coding, and also intelligent methods for node coordination and medium access. In addition to the challenges associated with the wireless medium, each specific wireless network application can also have its own set of challenges. For example, wireless sensor networks (WSNs) require energy-efficient methods for communication, since these networks rely on battery operated small wireless devices with sensing and limited processing capabilities. WLANs, on the other hand, are less energy restricted, but bandwidth is the major design constraint for these networks.

The effects of severe channel impairments can be mitigated through the use of multiple-antennas, i.e., spatial diversity techniques. In spatial diversity, the receiver is provided with multiple copies of the original signal through independent fading paths, thereby the fading of the resultant signal is reduced, leading to reliable and robust communication. Spatial diversity is particularly attractive as it can readily be combined with other forms of diversity, such as time and frequency diversity. However, in order to harness the diversity gains in multi-antenna systems, the antennas are required to be separated by at least half the signal wavelength, translating into 12.5 cm for common wireless equipment, such as IEEE 802.11 or 802.15.4. The wireless networks of the near future are envisioned to incorporate many tiny smart wireless nodes that are capable of sensing the medium, communicating with each other and working towards certain tasks. These networks require reliable communication architectures that do not impose size limitations.

Cooperative communication capitalizes on providing intended receiver with multiple copies of the original signal via the help of the neighboring nodes, so called relays (or cooperators) through independent channels, thereby mitigating the effects of fading. In contrast to the conventional forms of spatial diversity obtained with physical antenna arrays employed on a single node, in cooperative diversity multiple nodes employed with single antenna transmit cooperatively to form a virtual antenna array, and by this way, spatial diversity can be exploited without the need for implementing multi-antenna arrays on the nodes. This kind of spatial diversity obtained by forming virtual antenna arrays is named as cooperative diversity or user cooperation diversity.

The degree of performance improvement due to cooperative diversity is determined by the channel states of the cooperators. Selection of appropriate cooperators and resource allocation among those cooperators are intrinsically connected problems, solution of which is essential in exploiting cooperative diversity. The cooperative protocols of the physical layer are based on the naive assumptions that the best set of cooperating nodes are preselected, resources are already allocated, and all the transmissions are coordinated. However, selection, resource allocation, coordination and actuation of the cooperating nodes can only be realized with an appropriately designed cooperative medium access control (MAC) protocol.

The design of cooperative MAC protocols differs significantly from the conventional MAC protocol design. Conventional protocols aim to schedule and coordinate the transmissions to minimize the collisions and to reserve the medium to only a single user at a given time/frequency/code dimension. However, cooperation idea relies on a different paradigm: Possible cooperators overhear the transmissions of communicating entities and these relay nodes transmit the overheard signal in cooperation with the source node. In other words, cooperation relies on deliberate collisions as opposed to the conventional schemes which avoid collisions. Furthermore, in conventional MAC protocols if a node receives a packet that is not destined to itself, it ignores the packet and stays silent in order to prevent collision or interference. However, in cooperative systems, each node is not only responsible for its own packets but also each node hears the ongoing transmissions, and cooperates with other nodes if needed. Thus, in a cooperative MAC protocol, channel access and network allocation mechanisms need to be modified for utilizing cooperation. Moreover, the assessment of the need for cooperation is necessary, which can be carried out and announced by the source node, or the destination node, or in fully distributed systems this can be carried out autonomously by candidate relays, which also requires substantial modifications in the MAC design.

Having noted the primary design differences between the cooperative and conventional MAC protocols, the primary issues of cooperative MAC protocol design can be summarized as follows: (i) how many and which cooperators should be selected? (ii) how should the resources be allocated among the cooperators? (iii) how should the cooperators be actuated? The MAC protocol should be designed such that these issues are resolved jointly without causing a significant messaging burden on the network. Also, for exploiting the cooperative diversity, the system parameters should be optimized with respect to the application specific requirements of the network while considering the cost of realizing cooperation. Cooperation requires retransmission of the information, necessitating an extra time/frequency slot, and requires mechanisms for selection, coordination and actuation of the cooperating nodes, all of which also cause extra messaging, i.e., increased energy expenditure and overhead. Hence, designing a cooperative MAC protocol requires to consider all the costs of cooperation and make sure that the costs do not obliterate the benefits of cooperation. In particular, the network and protocol parameters should be carefully optimized for minimizing the cost of cooperation while also trying to achieve: (i) increased communication reliability, i.e., reduced average error probability over the time-varying wireless channel, (ii) increased transmission rate, which corresponds to decreased delay, (iii) increased transmission range, which corresponds to extended coverage area; or reduced transmit power, which corresponds to decreased interference and improved spatial reuse and (iv) reduced energy consumption per reliable communication, which corresponds to achieving required average error probability with reduced energy transmissions.

Cooperation has been shown to provide energy-efficiency as compared to direct transmission, in particular for cases where source-destination channel is not satisfactory for direct transmission. Energy saving is mainly due to the fact that packet retransmissions of the source node are avoided by employing cooperative transmissions, which also boost the signal reception as a result of diversity gain. Distributed implementation of cooperative communication imposes extra challenges on system design, because the energy savings provided by cooperative transmission may degrade as a consequence of the energy cost incurred by cooperation initiation stage, where the cooperation set is formed. That is why, energy-optimal cooperation set selection is important in harnessing the energy gains promised by cooperative communications. The amount of energy savings provided by cooperation depends on how many and which relays are selected for cooperation and how much transmit power is assigned to each relay. While transmit power allocation is related with the physical layer, initiation and coordination of cooperation is controlled by the Medium Access Control (MAC) layer. Hence, the optimal cooperative architecture requires a cross-layer approach.

### OBJECTS OF THE INVENTION

The present invention is a MAC design allowing cooperation in wireless networks by taking into account the operation and overhead of employing cooperation in each layer by accurately modeling the parameters of each layer as well as application specific performance requirements. In particular, for designing an energy-efficient architecture to be used in wireless networks, the hardware limitations and the power consumption cost of the wireless nodes is considered together with reliability requirements.

Carrier Sense Multiple Access (CSMA) based cooperative MAC protocol COMAC of the invention allows for multi-node cooperation and realizes cooperation with minimal overhead. As it is a general framework, it can be applied over different physical layer settings, such as IEEE 802.11 wireless local area networks or IEEE 802.15.4 based wireless sensor networks with many different data and streaming applications over wireless local area networks or wireless sensor networks applications, such as environment monitoring, industrial control, telemetry etc.

Proposed COMAC protocol is flexible, so that different relay selection metrics can be incorporated for realizing cooperation decisions. A low complexity, distributed joint relay selection and power assignment method is proposed. The distributed algorithm renders decentralized operation by relying on the individual decisions and computations of the relay nodes, different from the available literature that require the source or the destination to carry out relay selection and power assignment tasks.

The COMAC protocol involves a timer mechanism for coordinating the messages of the candidate relays and allowing them to determine the best set of relays and calculate their power levels in a distributed fashion, in accordance with the proposed distributed relay selection and power assignment algorithm.

The COMAC's timer mechanism minimizes the possible collisions in relays' messages. Still, COMAC introduces a method to resolve the collisions, if/when they occur. It introduces a sleep/wake-up mechanism for putting relay nodes into sleep, when they are not to be involved in the cooperation. This feature is shown to provide further energy savings of 33% in one cooperator case, 25% and 20% in two and three cooperators cases, respectively.

The performance of COMAC protocol together with relay selection and power assignment is shown to provide significant energy savings and increased throughput as compared to direct transmission, under different topologies and scenarios. It is observed that, by using COMAC, the throughput performance is improved by 5 times, which translates into an improvement by 2 orders of magnitude in the energy per bit performance in comparison to direct transmission (i.e., with the proposed cooperative protocol, the total energy consumed for delivering one bit successfully to the destination is reduced to 0.01th of direct transmission).

### BRIEF DESCRIPTION OF THE FIGURES

The figures whose brief explanations are herewith provided are solely intended for providing a better understanding of the present invention and are as such not intended to define the scope of protection or the context in which said scope is to be interpreted in the absence of the description.

FIG. 1 demonstrates a wireless system model with a source node, a destination node and N relay nodes according to the present invention.

FIG. 2 demonstrates COMAC frame sequence and related Network Allocation Vector (NAV) timers according to the present invention.

FIG. 3 demonstrates frame exchange procedure according to the present invention when cooperation initiation is not successful.

FIG. 4 demonstrates frame exchange according to the present invention with ACO collision resolution.

FIGS. 5 and 6 respectively demonstrate flowcharts of the operation of the source node and the relay nodes according to the present invention.

FIG. 7 demonstrates frame exchange for CDMA according to the present invention.

FIG. 8 demonstrates frame exchange for TDMA according to the present invention.

FIG. 9 demonstrates frame exchange and NAV settings according to the present invention.

FIG. 10 demonstrates radio states with sleep feature according to the present invention.

### DETAILED DESCRIPTION OF THE INVENTION

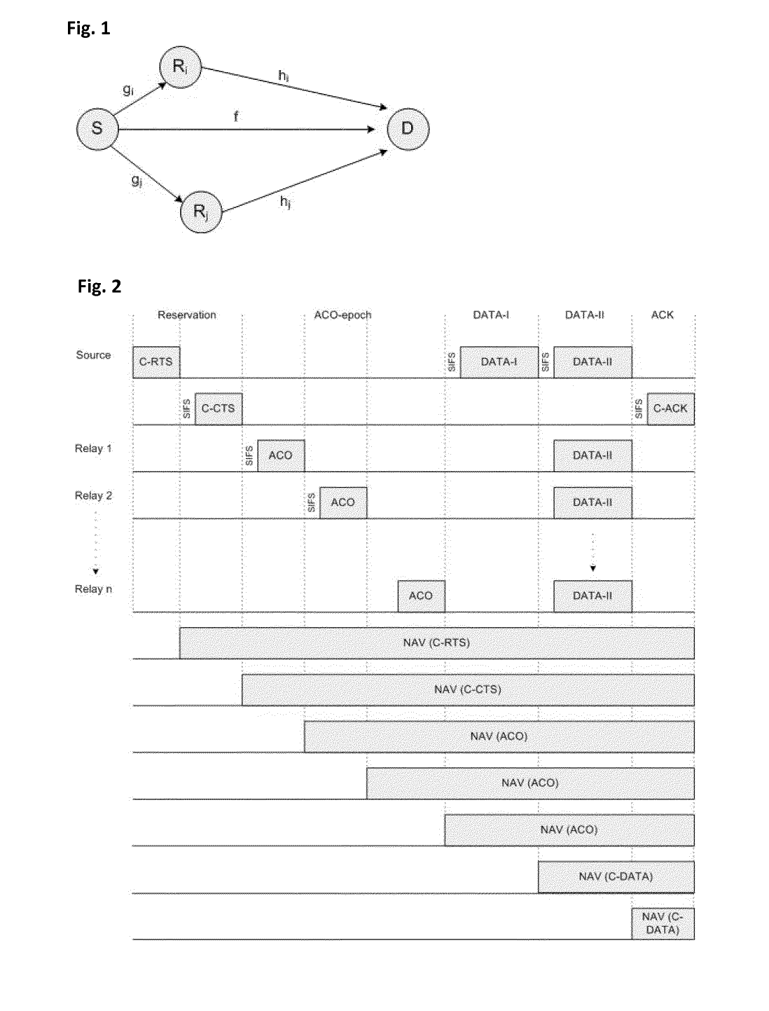

The present invention proposes a wireless system model with a source node, a destination node and N relay nodes, as depicted in FIG. 1. The aim is to find the group of relays that minimizes the total energy consumption to send one successful bit to destination, under given reliability condition, which is expressed in terms of average BER level.

The COMAC protocol operation according to the present invention is performed such that when the source node has a packet destined to the destination node, a Cooperative Request To Send (C-RTS) packet is initially sent. Having received this packet correctly, the destination node replies back with a Cooperative Clear To Send (C-CTS) packet. A neighboring node that receives both C-RTS and C-CTS is a candidate relay for cooperative transmission. All candidate relays make a decision to participate in cooperation or not, and if a relay node decides to cooperate, it announces this decision with an Available to COoperate (ACO) packet. COMAC protocol reserves a predefined duration, namely ACO epoch, for relays to announce their decisions. ACO epoch length is a configurable protocol parameter and it can be calculated as K*T_{ACO}, where T_{ACO}=P_{ACO}+T_{SIFS} is the duration of an ACO slot, within which an ACO packet can be sent and the node can switch to receive mode for listening to other ACOs. P_{ACO} being the transmission duration of an ACO packet and T_{SIFS} is the duration of one short inter frame spacing (SIFS) according to IEEE Standard 802.11-1997. The parameter K defines and limits the number of relays that can participate in cooperation.

Within the ACO epoch, all candidate relays send their intention for joining cooperation via the ACO packets. The ACO packets are transmitted according to the decisions of the relays that are coordinated via separate timers at the relays. For relay decisions, i.e., relay selection, each relay considers the state of the channel between itself and the source node, estimated via the reception of C-RTS packet, the state of the channel between itself and the destination node, estimated via the reception of C-CTS packet and the information retrieved from the ACO packet(s) from previous candidate relays(s). The relays that decide to join the cooperation send ACO packets. At the end of the ACO-epoch, if at least one ACO has been received successfully, i.e., if there is at least one candidate relay, the source node sends DATA_{I} packet, and in the second phase, the selected relay nodes repeat this packet together with the source node. The power levels of the relay nodes is adjusted according to the optimal solution.

Once data is sent cooperatively and received successfully at the destination, the destination node replies back with a Cooperative Acknowledgement (C-ACK) message. If destination cannot receive the data packet successfully, then it does not send C-ACK packet. If the source node does not receive C-ACK packet within a predefined time period, it concludes that cooperative transmission ended up in failure and triggers retransmission procedure according to IEEE 802.11 Standard.

It is to be noted that relay selection is an integral part of COMAC according to the present invention, and it can be performed in a centralized or distributed manner based on an algorithm or via random selection. If the relay selection process ends up with failure, i.e., if there are no successfully received ACO packets at the end of the ACO-epoch, the source node reverts back to direct transmission, by sending an INFO packet. After that, the data is sent directly once to the destination, and upon successful reception, data is acknowledged by an ACK packet by the destination node. In case of failure, ACK is not sent, and the source retransmits the packet according to IEEE 802.11 Standard.

The operational approach of the protocol according to the present invention makes use of the concept of The Network Allocation Vector (NAV) that is tied with virtual carrier sensing mechanism in IEEE 802.11. The virtual carrier sensing is a logical abstraction which limits the need for physical carrier sensing at the air interface in order to save power. All MAC layer frames, in their headers contain a Duration field that specifies the total time required for the frame to be delivered and acknowledged. This time duration denotes the period over which the medium will be busy. The stations listening to the wireless medium read the Duration field of each incoming frame and set their NAV to the read value. NAV denotes a timer for a station specifying how long it must defer from accessing the medium.

The COMAC protocol according to the present invention makes use of the NAV concept of IEEE 802.11, so that the nodes that do not participate in cooperation defer, and they do not access the medium. Below is explained how NAV timer is adapted and set in the COMAC protocol.

NAV timer upon receiving C-RTS: Direct transmission is assumed here, and cooperative transmission is not taken into account, type of transmission is not decided yet. In this case, the NAV timer is set as:

D_{C-RTS}=3×T_{SIFS}+T_{C-CTS}+T_{DATA}+T_{ACK}+3*T_{max.prop.delay}

NAV timer upon receiving C-CTS: Type of transmission is still not decided, so the NAV timer is set as:

D_{C-CTS}=2×T_{SIFS}+T_{DATA}+T_{ACK}+2*T_{max.prop.delay}

NAV timer upon receiving ACO: Cooperative transmission is certain now. NAV timer is set as:

D_{ACO}=T_{ACO-epoch}+T_{ACO}

NAV timer upon receiving INFO: This packet informs nodes that source node will revert back to direct transmission. NAV timer is set as:

D_{INFO}=2λT_{SIFS}+T_{DATA}+T_{ACK}+2*T_{max.prop.delay}

NAV timer upon receiving DATA_{I}: If this is the first phase of cooperative transmission, the NAV timer is set as:

D_{C-DATAI}=2λT_{SIFS}+T_{DATA}+T_{ACK}+2*T_{max.prop.delay}

If this is a direct transmission, the NAV timer is set as:

D_{C-DATAI}=T_{SIFS}+T_{ACK}+T_{max.prop.delay}

NAV timer upon receiving DATA_{II}: NAV timer is set as:

D_{C-DATAI}=T_{SIFS}+T_{ACK}+T_{max.prop.delay}

Here, T_{SIFS} is the short inter frame spacing (SIFS) duration which includes the total time needed for a radio to switch from transmitting mode to receive mode. T_{max.prop.delay} is the maximum propagation delay between any two stations in the network. COMAC frame sequence and related NAV timers are depicted in FIG. 2.

All relay nodes that receive C-RTS and C-CTS are candidate relays for cooperation. However, the decisions as to which relays will be selected and what level of transmission power they will use, are yet to be made. A relay selection and power assignment algorithm is needed to complete ACO-epoch successfully. COMAC is a flexible protocol so that various relay actuation mechanisms can be incorporated into its framework. Optimal cooperator selection and power assignment according to the present invention is made as will be explained hereinafter.

In the system model of the present invention, N relay nodes in the neighborhood of a source node S and a destination node D are identified. Assuming that the cooperation set is composed of r relays, then possible cooperation sets can be listed as: C_{r,0}, C_{r,1}, . . . . The cooperative system first checks whether cooperation is needed or not, then the cooperating relays are selected during an ACO-epoch. Once the relays are selected, data frame is sent to the destination node in two phases: In phase 1, S transmits the frame with an energy-per-bit level of E_{b} Joules/bit. In phase 2, the nodes in the selected cooperation set, for instance C_{r,j}, cooperatively transmit the decoded-and-regenerated signal to the destination over orthogonal channels. Here, it is assumed that each cooperator Rᵢ in the cooperator set C_{r,j}, can adjust its transmit power level to a level ρ_{r,j}(i)*E_{b} J/b, where ρ_{r,j}(i) denotes the relay's relative power level with respect to the power level of the source, 0≦ρ_{r,j}(i)≦1, RᵢεC_{r,j}. This way, a power vector pⱼ is assigned to the cooperation set. Each member of this vector is the relative power level of corresponding relay node in the cooperation set. In the system model, independent Rayleigh fading is assumed for the direct channel and the relay channels. The channel coefficients for source destination (SD), source relay (SR) and relay destination (RD) channels, for instance for relay Rᵢ are, f, gᵢ, hᵢ, respectively, and the mean channel gains are σ_{f}, σ_{gi}, and σₕᵢ, respectively. Assuming that all channels have additive white Gaussian noise with power Nₒ, the instantaneous Signal-to-Noise Ratio (SNR) values for SD, SR and RD channels are found as follows:

[symbol]

=(E_{b}/N₀)*|f²|, [symbol] _{gi}=(E_{b}/N₀)*|gᵢ²|, [symbol] ₕᵢ=(E_{b}/N₀)*|hᵢ²|

Additionally, it is assumed that average channel statistics are given as follows:

[symbol]

_{f}=(E_{b}/N₀)*f², [symbol] _{gi}=(E_{b}/N₀)*gᵢ², [symbol] ₕᵢ=(E_{b}/N₀)*hᵢ²

For modeling energy consumption, the energy consumed by source, relay and destination nodes are taken into account while sending and receiving data signal. Energy consumed by transmitter and receiver circuitries is also taken into account. Assuming all nodes in the network have identical transmitter and receiver circuitries with power consumption levels of wₜ and wᵣ, energy cost per bit spent at transmit and receive circuitries can be calculated as Eₜ=wₜ/r_{b} and Eᵣ=wᵣ/r_{b}, respectively. Here, each node transmits at a constant bit rate of r_{b}, with no rate adaption. While calculating energy, an energy-per-bit cost model is used. The amount of energy needed to successfully transmit one bit of data signal to destination is calculated. In this regard, it is assumed that the source node always transmits with its maximum available energy-per-bit level, E_{b}. E_{b} is calculated as E_{b}=εₜₐd^{a}, where εₜₐ is the energy-per-bit-meterₐ at the transmit amplifier and a is the path loss coefficient. Given a predetermined average BER target (Pₜₕ) and maximum transmit energy level (E_{b}), d represents the maximum source-destination separation that allows for successful communication. Here d values are used such that SD direct transmission is not possible. Moreover, relay nodes that contribute to data transmission in phase 2, spend ρᵣ,j(i)*E_{b} at transmit amplifiers. Based on these assumptions and findings, the total energy-per-bit cost of cooperative system is given in the equation (1) as:

$${ɛ}_{r , j} ( {ρ}_{r , j} ) = ( 1 + {\sum }_{{R}_{i} ∈ {C}_{r , j}} {ρ}_{r , j} ( i ) ) {E}_{b} + ( r + 1 ) {E}_{t} + ( 2 r + 1 ) {E}_{r} .$$

where C_{r,j} stands for the cooperation set and ρ_{r;j} stands for the power vector of the cooperating relays. In this formula the energy consumed in the transmit amplifiers of source and cooperating nodes as well as transmit and receive energy consumptions in source, relay and destination nodes are obtained. The algorithm is based on an optimization problem that minimizes the total energy of the cooperative system, while satisfying a target average bit-error-rate (BER) level. It is accordingly first aimed at finding the set of relay nodes that minimizes the total energy cost. The optimal relative power assignment for the cooperative system is computed as:

$$\begin{matrix}{ρ}_{r , j}^{*} = \frac{1}{{\overline{γ}}_{f}} {( Ω ( {C}_{r , j} , {\overline{γ}}_{f} ) {\prod }_{{R}_{k} ∈ {C}_{r , j}} \frac{{σ}_{f}^{2}}{{σ}_{{h}_{k}}^{2}} )}^{1 / r} - \frac{{σ}_{f}^{2}}{{σ}_{{h}_{k}}^{2} {\overline{γ}}_{f}} , & ( 2 ) \\ Ω ( {C}_{r , j} , {\overline{γ}}_{f} ) {=}^{Δ} \frac{Λ ( r , {\overline{γ}}_{f} ) Q ( {C}_{r , j} )}{{P}_{th} - {\overline{P}}_{b} ( {\overline{γ}}_{f} ) {Q}^{′} ( {C}_{r , j} )} & ( 3 ) \\ Λ ( r , {\overline{γ}}_{f} ) {=}^{Δ} \frac{1}{π} {\int }_{0}^{π / 2} \frac{{( sin φ )}^{2 ( r + 1 )}}{{sin}^{2} φ + {\overline{γ}}_{f}} & ( 4 ) \\ {\overline{P}}_{b} ( {\overline{γ}}_{f} ) {=}^{Δ} \frac{1}{2} ( 1 - \sqrt{{\overline{γ}}_{f} / ( 1 + {\overline{γ}}_{f} )} ) & ( 5 ) \\ Q ( {C}_{r , j} ) {=}^{Δ} {\prod }_{{R}_{i} ∈ {C}_{r , j}} exp ( - {γ}_{th} / {\overline{γ}}_{{g}_{i}} ) & ( 6 ) \\ {Q}^{′} ( {C}_{r , j} ) {=}^{Δ} 1 - {\prod }_{{R}_{i} ∈ {C}_{r , j}} exp ( - {γ}_{th} / {\overline{γ}}_{{g}_{i}} ) & ( 7 )\end{matrix}$$

In the above equations, Q is the probability that all cooperators in cooperation set can successfully decode and regenerate the source transmission, and Q′ is the probability that not all cooperators in the cooperation set can successfully decode and regenerate the source transmission.

P_{b}(_{f}) is the average BER of the direct SD channel, assuming binary phase shift keying, BPSK, modulation. Pₜₕ is the average BER target. This problem is solved via an iterative method and the resulting procedure is summarized in the following algorithm. Algorithm 1 for optimal power assignment is as follows:

```
Relay set: [symbol]    _{r,j}; [symbol]    ⱼ = [symbol]    _{r,j}; k = | [symbol]   ⱼ|; [symbol]     = {}
while k ≠ 0 do
  for Rᵢ ε [symbol]    ⱼ do
    Compute ρᵣ*_{,j}(i) for [symbol]    ⱼ via eqn. [symbol]
    if ρᵣ*_{,j}(i) > 1 then
      ρᵣ*_{,j}(i) = 1 [symbol]
      ← [symbol]    ∪Rᵢ
    end if
  end for [symbol]
  ⱼ ← [symbol]    ⱼ − [symbol]    ; k = | [symbol]   |; [symbol]     = {}
end while
```

Using the above algorithm, the optimal power assignment values can be calculated for relay nodes in a given cooperation set. However, there is only one cooperation set among possible cooperation sets that minimizes the total energy cost. The search for the optimal cooperation set is assured with the following inequality:

$${\sum }_{{R}_{i} ∈ {C}_{r}^{*}} {ρ}_{r}^{*} ( i ) - {\sum }_{{R}_{i} ∈ {C}_{r + 1}^{*}} {ρ}_{r + 1}^{*} ( i ) < \frac{{E}_{t} + 2 {E}_{r}}{{E}_{b}} . \qquad ( 8 )$$

Algorithm 2 for optimal cooperation selection and power assignment is as follow:

```
r = 1, [symbol]    * = {},
while C* = {} do
  find ρᵣ*_{,j} ∀ [symbol]   _{r,j}, j = 1, . . . , (r^{N}) [symbol]     find ρᵣ*, [symbol]    ᵣ*
  if ρᵣ* is not feasible, i.e., ∃Rⱼ ∈ [symbol]    ᵣ s.t. ρᵣ*(j) > 1 then
    r = r + 1
  else
    find ρᵣ*_{+1,j}, ∀ [symbol]   _{r+1,j}, j = 1, . . . , (ᵣ₊^{N}₁) [symbol]     find ρᵣ*₊₁, [symbol]    ᵣ₊₁
    if [symbol]     satisfied then [symbol]
      * = [symbol]    ᵣ*, ρ* = ρᵣ*
    else
      if [symbol]    ᵣ₊₁(ρᵣ*₊₁) < [symbol]    ᵣ(ρᵣ*) then [symbol]
        * =
      else [symbol]
        * = [symbol]    ᵣ*, = ρᵣ*
      end if
    end if
  end if
end while
```

Algorithm 2 above aims to find the best cooperator set to minimize the total energy cost. In this algorithm, for a feasible cooperation set (i.e. all power assignment values are lower than 1) a relay node is added into the cooperation set, if its addition reduces the total energy while the BER target is achieved. The energy cost of the inclusion of the next relay into the cooperation set is analyzed via inequality (8). If the inequality (8) is satisfied, then it is concluded that inclusion of the new relay increases the energy cost of the system, and hence new relay is not added to the existing cooperation set. If the given cooperation set is not feasible, then another relay is added to the cooperation set. This method is centralized, since the computation of ρ* requires the channel statistics of all relay nodes in the cooperative system. Implementation of this model necessitates that all channel information is available at a central node.

The above algorithm and solution is centralized, hence it requires sharing of all channel statistics, i.e., plenty of information to be exchanged between nodes, which is not efficient in terms of bandwidth and energy. For this reason, a distributed joint cooperation set selection and power assignment algorithm is proposed. This method is distributed, since each node makes its own decision to cooperate or not. The relay nodes announce their intention for cooperation using ACO messages, and each relay decides based on received RTS/CTS/ACO messages and measurements made while receiving those packets.

When the source, destination and relays exchange control packets, neighboring relays that hear these control packets analyze the transmission scheme. If direct transmission cannot satisfy BER criteria and cooperation is necessary, each relay considers whether it is feasible to cooperate, i.e., it computes the required power allocation via formula (2). If a relay node concludes that it should participate in cooperation, it becomes a candidate relay for cooperation and announces its decision to the neighboring nodes by sending its ACO packet. It is to be noted that if there are multiple candidate relay nodes, they should announce their availability in coordination, so that their announcements do not collide.

In the proposed COMAC protocol, the ordering of these announcements is handled by a timer mechanism, the ACO timer, which will be described hereinafter. The distributed cooperator selection and power assignment according to the present invention is described in Algorithm 3:

```
if γ_{g}^{ᵢ} ≧ γₜₕ then
  r = 0, Decision =
  while Decision = do
    if a cooperator's decision, say, Rᵢ, is received then
      r = r + 1, [symbol]    ᵣ ← [symbol]    ᵣ₋₁ ∪Rᵢ
      Compute ρᵣ*(j), ∀Rⱼ ∈ [symbol]    ᵣ via Algorithim [symbol]
      if ρᵣ^{j} is not feasible, i.e., ∃Rⱼ ∈ [symbol]    ᵣ s.t. ρᵣ*(j) > 1 then
        Decision = Cooperate
      else
        if [symbol]     is satisfied then
          Decision = Do not cooperate
        else
          if [symbol]    ᵣ(ρᵣ*) < [symbol]    ᵣ₋₁(ρᵣ*₋₁) then
            Decision = Cooperate
          else
            Decision = Do not cooperate
          end if
        end if
      end if
    else
      Decision = Cooperate
    end if
  end while
end if
```

The distributed optimal cooperator selection and power assignment algorithm described above is embedded within the COMAC protocol as follows. There are three main stages of operation: i) Reservation stage, where cooperative data transmission request is made by the source node, ii) ACO epoch, where the announcements of the candidate relays are sent, the cooperation set is formed and power levels are assigned, and iii) the cooperative data transmission stage, which includes phases 1 and 2 of cooperation.

Cooperative transmission starts with the reservation stage, which is RTS/CTS control packet exchange. The source node sends C-RTS and reserves the medium. The relay and destination nodes check whether they can successfully decode the message from source. At this point, relay and destination nodes have the instantaneous channel statistics of both the (source-relay) SR and (source-destination) SD channels, respectively. Hence, the relay and destination nodes can estimate average SNR values for SR and SD channels, [symbol] _{gi} and [symbol] _{f}, and the relay nodes can decide whether they are inside decoding region by comparing the average SNR estimate for SR link with SNR threshold. If average SNR estimate for SR link is greater than SNR threshold, then relay node decides that it can successfully decode data signal from source and hence it is a candidate for cooperation. However, it is to be noted that, at this point, the relay nodes do not know whether direct transmission is to be done or cooperation is needed. Similar to the relay nodes, the destination node uses average SNR estimate to check whether it can decode the packet, and if the average SNR estimate of SD link is lower than the SNR threshold value for the required average BER, then the destination concludes that direct transmission cannot be successful and cooperation is necessary to satisfy the average BER requirement. When the C-RTS packet is received, the destination node knows whether direct or cooperative transmission will be used and the relay nodes know whether they can cooperate or not.

In the next step, the destination node sends the C-CTS packet. The average SNR value of the SD link is also included in this packet, so that the relay nodes receiving C-CTS retrieve this information. Upon receiving C-CTS, the source node makes an estimate of the average SNR of the SD channel and it concludes whether direct transmission can satisfy the BER requirement. If cooperation is needed, the source node starts the timer for the ACO epoch and waits for the ACO messages from the candidate relays. Meanwhile, the relay nodes consider the average SNR of SD link and they themselves determine whether cooperation is necessary or not. If cooperation is required, each candidate relay node, Rᵢ, computes the relative power assignment value ρᵢ using formula (2). Each relay also calculates and starts an individual timer (within the ACO epoch, a timer which is a multiple of an ACO slot, T_{ACO}) and the corresponding ACO packet is sent when its timer expires. The purpose of individual timers per relay is to differentiate between relays and avoid collisions of ACO packets. Each ACO packet includes information for the most recent cooperation set, the average SNR of the SD link, the average SNR of SR and RD links and the power assignments of the relay nodes in the current cooperation set.

Each candidate relay node that receives the first ACO packet retrieves the existing cooperation set, average SNR values and relative power assignment value of the relay node in cooperation set and reconsiders its decision of cooperation and sends itself an ACO packet. Each candidate relay node that receives this second ACO packet can be in two states: 1) If it has already sent an ACO, then it will certainly participate in cooperation. Upon receiving the new ACO, this node just reads and updates the cooperation set, obtains the power assignment vector and learns its new relative power assignment value. 2) If the relay did not send its ACO packet previously (i.e., its ACO timer has not expired yet), then it reconsiders its cooperation decision as follows: If the existing cooperation set already satisfies BER requirement, then this relay checks whether it can decrease the energy-per-bit cost of the cooperative system. If participation of this new relay further decreases the energy cost, then relay decides to join cooperation; if not, then this relay node decides not to cooperate, it cancels its ACO timer and goes to idle state. If the existing cooperation set does not satisfy the BER requirement, then this new relay joins cooperation without checking the energy requirements. Having decided to join cooperation, the relay adds itself to the cooperation set, modifies the relative power assignment vector and starts its ACO timer again. An ACO packet is sent accordingly.

As an example scenario, it can be assumed that timer for R₁ expires first, hence relay node R₁ sends its ACO packet. This packet includes the relative power assignment vector ρ*_{1,1}. R₁ also informs other nodes about its channel statistics, σ_{g1}, σₕ₁. Now, inside the cooperation set there is only one relay, R₁. When other relays hear the ACO message from R₁, they assume that R₁ will exist in cooperation set and reconsider their decision and recalculate relative power assignment vector based on the information received from R₁. If previous cooperation set is not feasible or if total energy-per-bit cost of the system can further be decreased by participation of Rᵢ into the cooperation, relay Rᵢ favors to cooperate. For example, assuming that the next candidate relay in order is R₂, then its ACO timer will expire next and R₂ will send its ACO packet. Upon receiving the ACO message from R₂, the other relays will have latest cooperation set, relative power assignment vector and the channel information (σ_{g1}, σₕ₁, σ_{g2}, σₕ₂) of the relays in the current cooperation set R₁, R₂, and each candidate relay applies the same procedure described in the previous step for determining whether or not to join the cooperation set. If it decides to join cooperation, it sends its ACO packet with the new power assignments. If, after hearing an ACO packet, such as from R₂, a node decides not to cooperate; it cancels its previous ACO timer and goes to idle state. As this procedure is repeated iteratively, the optimal cooperator set is formed incrementally and the search is completed by the end of the ACO epoch.

At the end of ACO epoch, if optimal cooperation set is found, the source node starts cooperative transmission by sending data packet in phase 1. The relay nodes receive and copy this packet. In phase 2, the source and the nodes in the cooperation set cooperatively transmit the data packet to the destination node over orthogonal channels at the assigned optimal power levels. When the destination node successfully receives the packet cooperatively sent at phase 2, it acknowledges the data by a C-ACK packet. The source node receiving the C-ACK packet infers that cooperative transmission is completed with success. If the destination cannot successfully receive data packet in phase 2, it does not send C-ACK packet, and the source node initiates a retransmission in cooperation mode. If a feasible cooperation set cannot be found at the end of ACO epoch, then the source node reverts back to direct transmission. In such a situation, source node informs the relay nodes and the destination node with an INFO packet.

It is to be noted that, successful delivery of the ACO packets is important for this distributed system to work, hence collisions of ACO packets should be avoided. For this purpose, in the protocol according to the present invention, the ACO timers are assigned to arbitrate the transmissions of candidate relays, while at the same time best relays are prioritized and included in the final cooperation set. Here, in addition to standard approaches, such as predefined timer and random timer durations, new methods are proposed according to the present invention for determining the ACO timer per relay, where the ACO timer is based on relative power assignments of the relays, on the quality of SR and/or RD channels, or a combination of both, as described hereinafter.

ACO timer design in COMAC is realized in the following manner: each relay makes its own decision in a distributed manner, and via the ACO packet, it sends its decision of cooperation within the ACO-epoch as explained above. If the relay nodes send their ACO timers at the same time, then ACO packets will collide, and either an optimal solution cannot be found or a suboptimal cooperation set is found at the end of ACO-epoch. ACO timer design is important to successfully differentiate the ACO packets of the relays from each other. The present invention proposes four timer schemes, the usage of which depends on the amount of available information about channel statistics.

Predefined timer values: In this design, each relay node has a predefined timer value, so that the relays in a cooperation set transmit their ACO packets in a unique order determined by the location and the channel characteristics of the relays. This timer design results in optimal cooperator selection and leads to most efficient energy consumption, while also eliminating the possibility of ACO collisions. However, it is only applicable for cases when the location and average channel characteristics of nodes are static and precisely known (and not changing), so that the optimal order of relays can successfully be calculated beforehand.

Timer based on random values: This timer is designed for cases when location and channel information is not available. Each relay node chooses a random value to determine its ACO-timer. Resulting random number corresponds to a random ACO slot inside ACO-epoch. However, this design can raise two problems: Two relays may choose the same ACO slots, resulting in a collision. Additionally, a relay that needs to spend large amount of energy for cooperation may be chosen, instead of a more energy effective relay. Nevertheless, this scheme cannot promise selection of the optimal cooperator set, but it avoids ACO collisions, to some extent; its strength is in its simplicity.

Timer based on power assignment: ACO-timer is mainly used for optimally arranging the order of candidate relays to participate in cooperation. Two important concerns when designing an ACO-timer can be considered as: 1) Resulting relay order should favor minimal total energy consumption of cooperative system. 2) The ACO-timer should minimize ACO-collisions. The main motivation is to reduce the total energy consumption of the cooperative system, which is defined in equation (1). Since the total energy consumption of cooperative system is proportional to the relative power assignment vector of relay nodes, the present invention proposes to utilize the relative power assignment values of the relays, ρ_{1,1}(i), as the metric to build an effective ACO-timer. Relay nodes can calculate their timers after receiving the C-CTS packet, as the power assignments are calculated for each relay (as if it is the only relay in the cooperation set). Hence, each relay determines its ACO-timer based on its average channel conditions only. Calculation of the ACO timer value for relay node Rᵢ can be generalized as:

tᵢ=a*(ρ_{1,1}(i))^{b} (9)

Here, the constants a and b help to adjust timer to support optimal timer functionality for all scenarios. Relays with low ρ_{1,1} values are expected to be more energy efficient, so they should transmit their ACO packets earlier. Therefore, the timer value should be decreasing as ρ_{1,1} increases, which can be provided by selecting positive values for the exponent b. Secondly, the ACO-timer should cause minimum number of ACO packet collisions. ACO packet collision is observed in the following situations: 1) When the ACO-timer value is larger than the ACO-epoch duration. 2) Minimum difference between ACO-timers of relays is larger than the maximum propagation delay in the network. By considering node distributions over different topologies (horizontal, vertical and square grid), the power assignments and ACO timers are computed considering different values of (a, b), and the number of collisions for each pair, (a, b), is recorded. After running extensive simulations, it was established that the coefficients should be selected as a=0.25 and b=0.25, so the calculation of the timer for relay i is given by:

tᵢ=0.25*(ρ_{1,1}(i))^{0.25} (10)

Timer based on relative power assignment value (ρ) and instantaneous channel power (P_{rd}): The timer design explained previously favors the relays with lower relative power assignment values to join the cooperation set earlier. This model works fine for selecting optimal relays, however when candidate relay nodes are located at symmetrical positions with respect to both source and destination, their ACO timers can be similar, resulting in a collision (This is because the relative power assignment considers the average channel SNRs of the SD, SR and the RD links). In case of a collision, the involved ACO packets will not be analyzed properly; optimal cooperation set will not be found. In order to overcome this problem, the present invention modifies the previous metric so that, in addition to the relative power assignments, the instantaneous power level measured over the RD link is also considered. Due to independent fading across different nodes, the instantaneous power of the signal received over the RD link will be different for different relay nodes even when they are symmetrically located. Hence the collision problem observed in the previous scheme is alleviated. In the final form of the metric, the RD channel power is to be normalized with respect to the SD channel power, and the coefficients are again selected after exhaustive simulations, considering various topologies, resulting in the timer for Rᵢ to be calculated as:

$${t}_{i} = 0.25 * {( {ρ}_{1 , 1} ( i ) )}^{0.25} + 0.2 * {( \frac{{P}_{rd} ( i )}{{P}_{sd}} )}^{- 0.25} \qquad ( 11 )$$

Collision resolution is dealt with as follows: Despite the fact that a successfully designed ACO timer can generate ACO timer values that avoids collisions, still there is the chance to have ACO packet collisions. For instance, it may not be possible to implement a complicated timer mechanism, considering relative power levels etc., but only the random scheme can be implemented, or the timer based on relative power levels could be employed, but the topology can be symmetric; even worse, on top of symmetric topology the relay channels could be correlated resulting in similar RD channel power levels. In order to handle such cases, it is essential to have a collision resolution method for resolving collisions on the ACO packets. For this purpose, a modification can be done on the COMAC protocol, by introducing a second ACO epoch to the frame exchange.

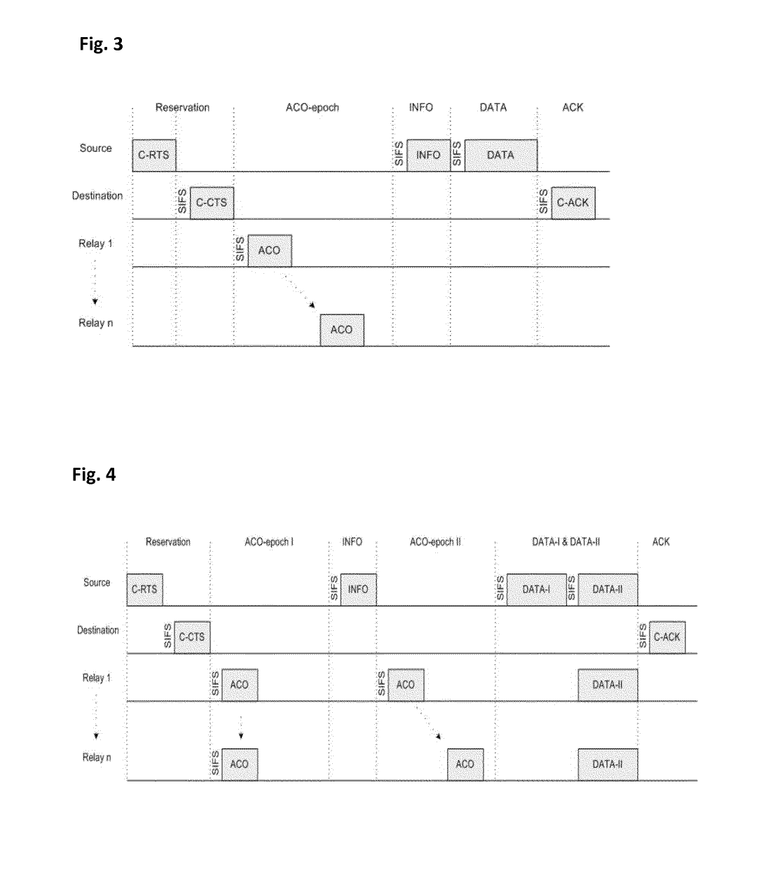

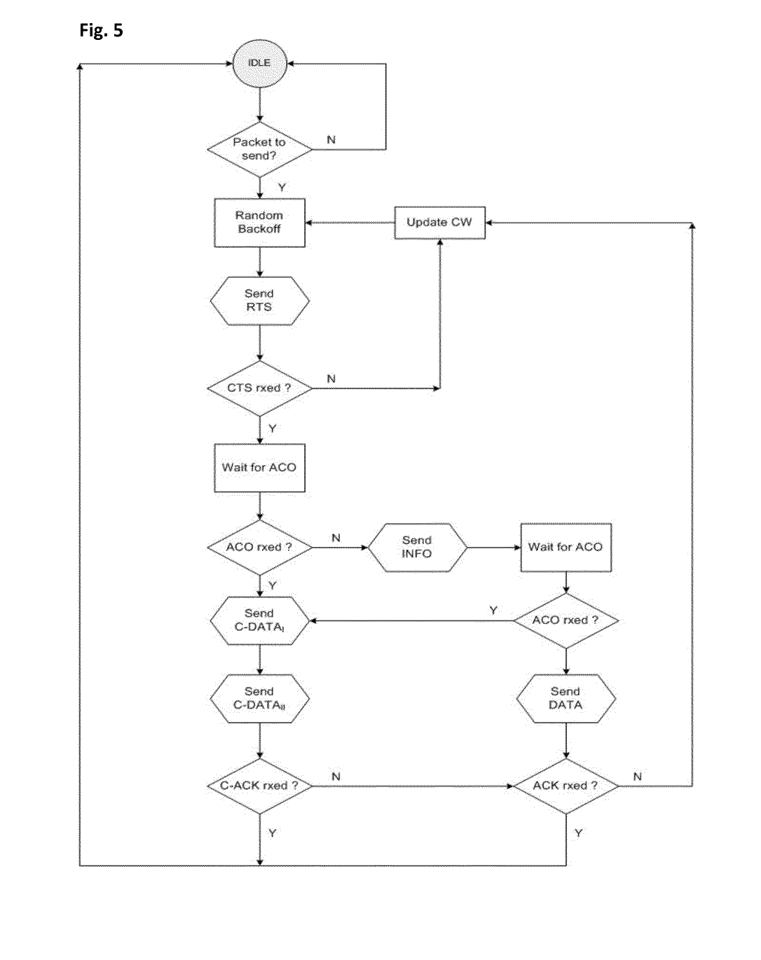

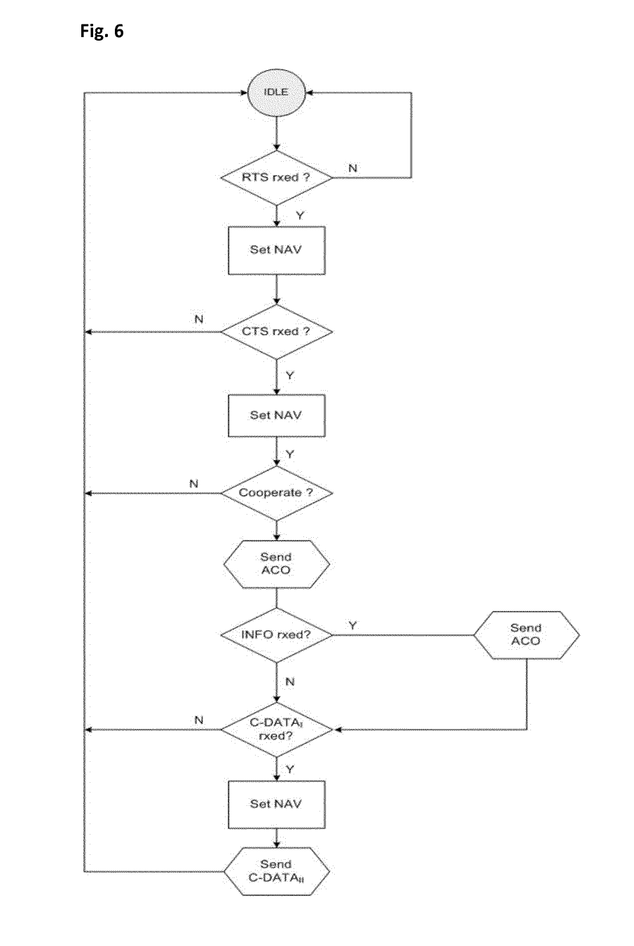

In the plain COMAC protocol, without the collision resolution feature, at the end of the ACO epoch, if an optimal cooperation set is not found, the source node aborts cooperative transmission by sending an INFO packet, and reverts back to direct transmission, as shown in FIG. 3.

In the proposed collision resolution feature for COMAC, when the ACO epoch ends, the source node considers the estimate for the received power at destination, based on existing average channel statistics and the relative power assignment values in the ACO packets. Using this estimation, the source node decides whether the existing cooperation set can be successful or not. If the source node senses an ACO collision and the existing cooperation set is not satisfactory, in other words when the source node decides that optimal cooperation set is not found in first ACO epoch, ACO_{I}, then it starts a second ACO-epoch, ACO_{II}. In the second ACO-epoch, the relay nodes need to recalculate their ACO timers. It is obvious that if the relay nodes use same metrics to calculate the ACO timers, again ACO packet collisions would be observed during ACO_{II}. In order to successfully differentiate ACO timers in the second ACO epoch, instantaneous RD link power levels are used. However, if this information is not available, then the relay node can assign a new timer based on random values. In such a case, the relay node generates a random number, calculates the duration for random number of ACO slots, and adds this duration to its previous timer value. The likelihood of two colliding relays in ACO_{I}, resulting in the same ACO timer value in ACO_{II} is small, so the collision will be resolved.

When the optimal cooperation set cannot be found in ACO_{I}, the relay and destination nodes are informed by the source node via the INFO message. Upon receiving the INFO message, the relay and destination nodes understand that the first ACO phase is not successful and second ACO phase will start, and update their NAV timers accordingly. If the second ACO phase results in an optimal cooperation set, the source node ends ACO_{II} and sends the data signal. If the second ACO phase is again unsuccessful, then the source node reverts back to direct transmission.

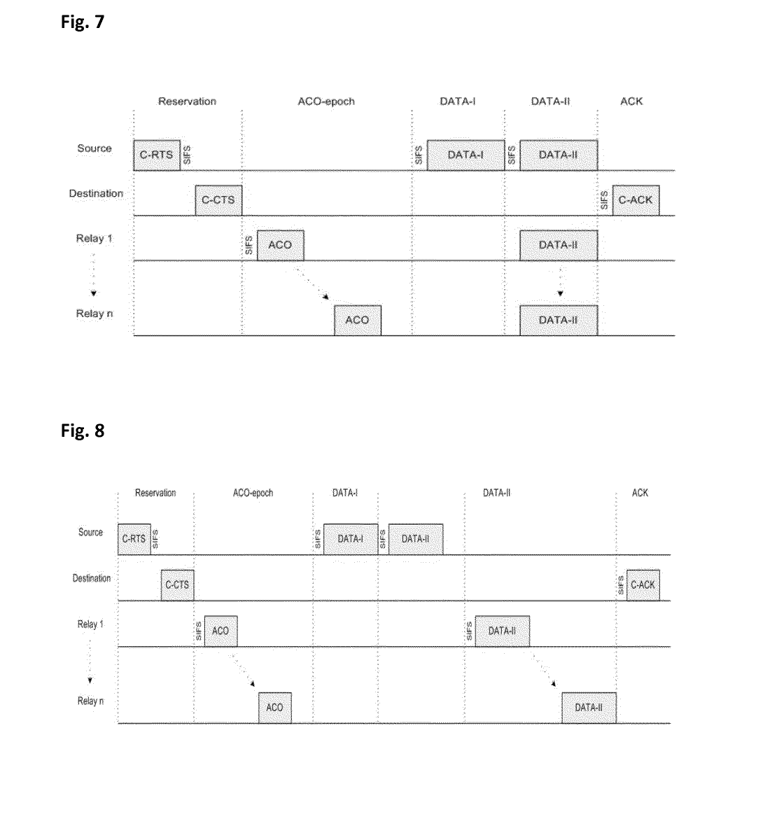

Cooperation Mode: During the second data phase of cooperative transmission, the source node and relay nodes transmit the data signal together. For COMAC, the two well-known orthogonal multiple access schemes Code Division Multiple Access (CDMA) and Time Division Multiple Access (TDMA) are considered. When CDMA is employed in COMAC DATA_{II} phase, each node sends its data signal copy (all scrambled by different spreading codes) at the same time, as depicted in FIG. 7. When TDMA is employed in COMAC, in phase 2, each node sends its data signal in a separate time slot, as shown in FIG. 8. The order of cooperation announcement (ACO packets) can define the order of data transmission in phase 2. This multiple access method, increases total transmission time, which causes a reduction in throughput; however it is much easier to implement. COMAC protocol is flexible to work with both schemes.

Sleep Feature: Energy efficiency in COMAC is mainly provided by optimal relay selection and power assignment. As explained previously, COMAC provides the multiple access interface and distributed implementation of optimal relay selection and power assignment algorithm, and further energy savings can be achieved by introducing an additional sleep feature to COMAC.

In general, radios operate in four different modes, namely, idle, receive, transmit and sleep. While it is expected that the radio consumes the highest amount of energy in the transmit and receive modes, in most cases, operating in idle mode also results in significantly high energy consumption, because the radio electronics are turned on and continually decode radio signals, even noise, to detect the presence of an incoming packet. Different measurements report the ratio of energy consumption during idle, receive and transmit modes as, 1:1.05:1.4, 1:1:2.7, and 1:2:2.5. It is thus desirable to completely shut down the radio rather than staying in idle mode. However, switching a radio on and off very frequently can sometimes result in even more energy consumption, because of the start-up power. Moreover, as the transmission packet size gets smaller, the transition energy becomes dominant to the energy consumed while receiving or transmitting packets.

On top of radio operation, when the operation of a general MAC protocol is considered, the major sources of energy waste are collisions, overhearing and idle listening. Collisions cannot be totally alleviated in a random access type MAC. Considering the COMAC design, there are precautions to reduce collisions due to the reservation stage (C-RTS/C-CTS exchange) and virtual carrier sensing (i.e., NAVs). Furthermore, the intelligent ACO timers can minimize ACO collisions by coordinating the transmissions of candidate relays, and even for the cases of collision, the ACO collision resolution mechanism is introduced. Overhearing considers the nodes that receive messages which are not destined to them. In the COMAC protocol, during the ACO epoch, the nodes that will not participate in cooperation overhear the ACO packets from candidate relays. Also, the nodes that are neither cooperators nor destination overhear the data packets. Considering idle listening, all nodes stay in idle state even when they are not receiving a packet, in order to sense the medium and receive possible incoming packets. During the ACO epoch and also during the data phase, a node that is neither a cooperator nor destination does not need to stay in idle state. Therefore, there is further room for savings in COMAC's energy consumption. Here, the sleep feature is introduced to the COMAC protocol, so that the relay nodes that decide not to cooperate go to a sleep state and wake up after cooperative transmission ends.

In the COMAC protocol, the relay nodes decide whether they will cooperate or not when they receive C-CTS or when they receive an ACO packet during the ACO epoch. If a relay node concludes that it will not cooperate, then it sets its NAV timer for the rest of the frame exchange and waits in idle state until the end of cooperative transmission. This provides virtual carrier sensing, so that such a node does not attempt to transmit itself. Although idle mode consumes less power as compared to reception and transmission, however, as reported above, a node in idle state spends energy for staying in idle state, hearing and receiving the packets in the medium that are not destined to itself.

With the sleep feature according to the present invention, as the relay nodes that will not cooperate set their NAV timers, they go to a sleep state, which lasts for the NAV duration. During this sleep period, the energy consumption of such nodes is minimized, since idle listening and overhearing costs are totally eliminated. Implementation of this sleep model requires sensitive adjustment of NAV timers. If NAV timers are not set correctly undesired results may occur. If a node wakes up before the cooperative transmission ends, then there will be unnecessary energy consumption for that remaining time. If a node stays in sleep state after transmission ends, then there is the risk that this node cannot receive the C-RTS and/or C-CTS packets of the next cooperative transmission. For this purpose, in COMAC protocol with the sleep feature, it is proposed to adjust the NAV timers of the relay nodes, so that they set their NAV timers depending on whether cooperative transmission is on or not. Specifically, each node makes its decision to go to sleep state at three instances: upon receiving the C-CTS packet, upon receiving an ACO packet and upon receiving the INFO packet.

Upon receiving the C-CTS packet, a relay node learns about the transmission scheme, whether it is direct or cooperative. Also, after the C-CTS packet, the relay also knows whether it is a candidate relay or not. As described earlier, making use of the average channel information gathered from C-RTS and C-CTS packets, the relay node determines if it will be involved in the cooperation. At this point, if the relay node infers that cooperative transmission is intended, however it will not be a candidate, then this relay node should set its NAV timer so that it does not access medium till the end of ACO epoch, and even further, stay in sleep mode during this interval. When the NAV timer expires at the end of the ACO epoch, since it is not certain yet, whether direct or cooperative transmission will be employed, a new NAV timer will be set depending on the decision of the source node, which is declared by the transmitted packet. If the data packet is transmitted by the source node, then this is phase 1 of cooperative transmission; if INFO packet is transmitted the source node is reverting to direct transmission.

If after the reception of the C-CTS packet, the relay node is a candidate relay, it will set its ACO timer and wait for its turn in the ACO epoch. Upon receiving an ACO packet, the candidate relay executes cooperation decision function by making use of the information in the received ACO packet. If the decision function indicates that this relay is no longer a candidate relay, relay node should then set its NAV timer until the end of the ACO epoch and goes to sleep; if the relay is to be included in the cooperator set, it remains in idle state.

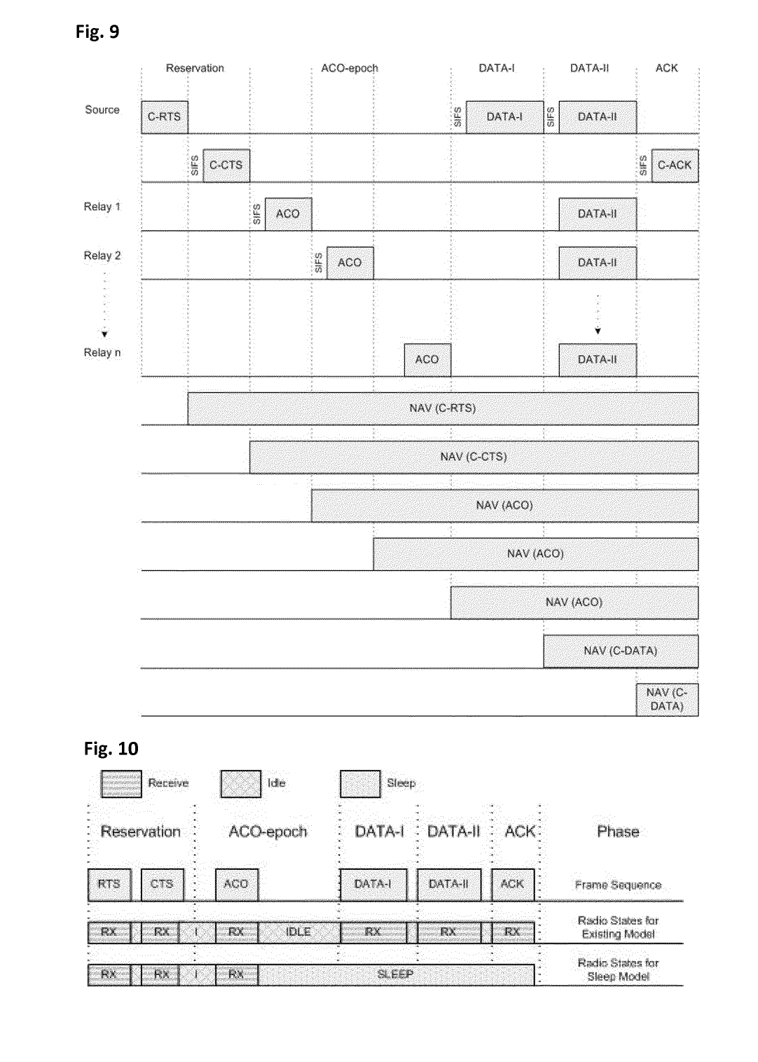

The third point of decision for sleeping is at the end of the ACO epoch. All the sleeping nodes wake up at this point and start to receive the next packet. They check the type of packet from the header of incoming packet and immediately go to sleep state for the NAV period, if packet type is INFO, which indicates direct transmission. In this case, the NAV timer is set to the duration of a data packet and an acknowledgement packet. If type of packet is DATA, and if the relay node is not in the final cooperation set, then it goes to sleep state for the NAV duration, which is set until the end of cooperative transmission frame exchange period (This NAV timer equals to twice the duration of the data packet plus the duration of acknowledgement packet). It is to be noted that, the additional inter frame spacings and propagation delays are included for each NAV timer by default. The setting of the NAV timer upon reception of different packets is shown in FIG. 9. FIG. 10 illustrates the radio states for a relay node that does not participate in cooperation and hence goes to sleep. In this scenario, the relay node receives C-RTS and C-CTS, and is a candidate relay which decides not to cooperate upon receiving an ACO packet from another relay node.

1. A method of communication in a wireless network for fining group of relays that minimizes total energy consumption to send one successful bit to destination node in a centralized or distributed manner, under reliability condition expressed in terms of average BER level, said method comprising three main stages,
i) reservation stage, where cooperative data transmission request is made by the source node, said reservation stage comprising the steps of sending of a Cooperative Request To Send (C-RTS) packet to the destination node by a source node, replying back by said destination node with a Cooperative Clear To Send (C-CTS) packet,
ii) Available to COoperate (ACO) epoch, where the announcements of the candidate relays are sent, said Available to COoperate (ACO) epoch stage comprising the steps of making of a decision by a neighboring relay node that receives both said Cooperative Request To Send and Cooperative Clear To Send packets on whether to participate cooperative transmission and announcement of cooperative transmission participation decision by said neighboring relay nodes with an Available to COoperate (ACO) packet in the manner that Available to COoperate packets by candidate relays are transmitted according to the decisions of the relays and that each relay considers the state of the channel between itself and the source node in terms of the average SNR, estimated via the reception of Cooperative Request To Send packet, the state of the channel between itself and the destination node in terms of the average SNR, estimated via the reception of Cooperative Clear To Send packet and
iii) the cooperative data transmission stage, where the source node starts a transmission by sending a data packet, the relay nodes receiving a cony of this packet and the source node and the nodes in the cooperation set cooperatively transmitting the data packet to the destination node over orthogonal channels.

2. A method of communication in a wireless network as set forth in claim 1, wherein in said cooperative data transmission stage, data frame is sent to the destination node in two phases in the manner that in phase 1, the source noide transmits the data frame with an energy-per-bit level of E_{b} Joules/bit and in phase 2, the source node and the nodes in the selected cooperation set cooperatively transmit the decoded-and-regenerated signal to the destination node over orthogonal channels.

3. A method of communication in a wireless network as set forth in claim 1 or 2 wherein the step of making of a decision by a neighboring relay node whether to participate cooperative transmission is based on information as to state of the channel between itself and the source node, estimated via the reception of C-RTS packet, state of the channel between itself and the destination node, estimated via the reception of C-CTS packet and information retrieved from the previous ACO packet or packets from cooperative transmission candidate relays.

4. A method of communication in a wireless network as set forth in claim 3, wherein information as to state of the channel between the relay and the source nodes as well as between the relay and the destination nodes is obtained from instantaneous channel statistics of both the source-relay (SR) and source-destination (SD) channels.

5. A method of communication in a wireless network as set forth in claim 4, wherein the relay and destination nodes estimate from said instantaneous channel statistics, average SNR values [symbol] _{gi} and [symbol] _{f}, for the source-relay (SR) and source-destination (SD) channels and the relay nodes decide whether they are inside decoding region by comparing the average SNR estimate for source-relay (SR) link with SNR threshold.

6. A method of communication in a wireless network as set forth in claim 5, wherein the relay nodes decide that whether they are able to decode data signal from the source node and they are a candidate or not for cooperation in the event that average SNR estimate for source-relay (SR) link is greater than SNR threshold.

7. A method of communication in a wireless network as set forth in claim 5, wherein the destination node uses average SNR estimate to check whether it can decode the packet, and if the average SNR estimate of source-destination (SD) link is lower than the SNR threshold value for required average BER, then the destination node concludes that direct transmission cannot be successful and cooperation is necessary to satisfy the average BER requirement.

8. A method of communication in a wireless network as set forth in claim 6, wherein upon receiving C-CTS, the source node makes an estimate of the average SNR of the source-destination (SD) channel and it concludes whether direct transmission can satisfy the BER requirement so that if cooperation is needed, the source node starts timer for the ACO epoch and waits for ACO messages from relays candidate for cooperative transmission.

9-28. (canceled)

29. A method of communication in a wireless network as set forth in claim 7 wherein upon receiving C-CTS, the source node makes an estimate of the average SNR of the source-destination (SD) channel and it concludes whether direct transmission can satisfy the BER requirement so that if cooperation is needed, the source node starts timer for the ACO epoch and waits for ACO messages from relays candidate for cooperative transmission.

30. A method of communication in a wireless network as set forth in claim 29, wherein the relay nodes receiving C-CTS consider the retrieved average SNR of the source-destination (SD) link and they themselves determine whether cooperation is necessary or not and if cooperation is required, each candidate relay node computes its relative power assignment value ρᵢ.

31. A method of communication in a wireless network as set forth in claim 30, wherein the relay node that decides to cooperate announces its cooperative transmission participation decision with an Available to COoperate packet.

32. A method of communication in a wireless network as set forth in claim 31, wherein said Available to COoperate packet includes information for the most recent cooperation set, the average SNR of the SD link and the average SNR of SR and RD links and the power assignments of the relay nodes in the current cooperation set.

33. A method of communication in a wireless network as set forth in claim 32, wherein each candidate relay node that receives the first Available to COoperate packet retrieves the existing cooperation set, average SNR values and relative power assignment value of the relay node in cooperation set and reconsiders its decision of cooperation and sends itself a second ACO packet.

34. A method of communication in a wireless network as set forth in claim 33, wherein each candidate relay node that receives said second ACO packet, participates in cooperation if it has already sent an ACO, said relay node receiving said second ACO packet reads and updates the cooperation set, obtains the power assignment vector and learns its new relative power assignment value.

35. A method of communication in a wireless network as set forth in claim 31, wherein each relay calculates and starts an individual timer within the ACO epoch and the corresponding Available to COoperate packet is sent when its timer expires so that collisions of ACO packets between relays is avoided by individual timers per relay.

36. A method of communication in a wireless network as set forth in claim 33, wherein each relay calculates and starts an individual timer within the ACO epoch and the corresponding Available to COoperate packet is sent when its timer expires so that collisions of ACO packets between relays is avoided by individual timers per relay, and wherein each candidate relay node that receives said second ACO packet reconsiders its cooperation decision if it did not previously send its ACO packet and its ACO timer has not yet expired in the manner that if the existing cooperation set already satisfies BER requirement, then the candidate relay node checks whether it can further decrease the energy-per-bit cost of the cooperative system, if so, it decides to join cooperation, and if on the contrary, then it decides not to cooperate, cancels its ACO timer and goes to idle state and if the existing cooperation set does not satisfy the BER requirement, then it joins cooperation without checking the energy requirements.

37. A method of communication in a wireless network as set forth in claim 36, wherein said candidate relay node having decided to join cooperation, adds itself to the cooperation set, modifies the relative power assignment vector and starts its ACO timer again so that an ACO packet is sent accordingly.

38. A method of communication in a wireless network as set forth in claim 37, wherein in said cooperative data transmission stage, data frame is sent to the destination node in two phases in the manner that in phase 1, the source noide transmits the data frame with an energy-per-bit level of E_{b} Joules/bit and in phase 2, the source node and the nodes in the selected cooperation set cooperatively transmit the decoded-and-regenerated signal to the destination node over orthogonal channels, and wherein at the end of ACO epoch, if optimal cooperation set is found, the source node starts cooperative transmission by sending data packet in phase 1, the relay nodes receive and copy this packet and in phase 2, the source and the relay nodes in the cooperation set cooperatively transmit the data packet to the destination node over orthogonal channels at the assigned optimal power levels.

39. A method of communication in a wireless network as set forth in claim 38, wherein when the destination node successfully receives the packet cooperatively sent at phase 2, it acknowledges the data by a C-ACK packet and the source node receiving the C-ACK packet infers that cooperative transmission is completed with success and if on the contrary the destination cannot successfully receive data packet in phase 2, it does not send C-ACK packet, and the source node initiates a retransmission in cooperation mode, if a feasible cooperation set cannot be found at the end of ACO epoch, then the source node reverts back to direct transmission.

40. A method of communication in a wireless network as set forth in claim 37, wherein in said cooperative data transmission stage, data frame is sent to the destination node in two phases in the manner that in phase 1, the source noide transmits the data frame with an energy-per-bit level of E_{b} Joules/bit and in phase 2, the source node and the nodes in the selected cooperation set cooperatively transmit the decoded-and-regenerated signal to the destination node over orthogonal channels, and wherein at the end of ACO epoch, if optimal cooperation set is found, the source node considers estimate for the received power at destination, based on existing average channel statistics and the relative power assignment values in the ACO packets and decides whether the existing cooperation set can be successful without an ACO collision, if needed, it starts a second ACO epoch in which the relay nodes need to recalculate their ACO timers.

41. A method of communication in a wireless network as set forth in claim 40, wherein the relay and destination nodes are informed by the source node via the INFO message that the optimal cooperation set cannot be found in the ACO epoch and the relay and destination nodes accordingly update their NAV timers, the second ACO epoch is initiated accordingly and if it results in an optimal cooperation set, the source node sends the data frame, otherwise it reverts back to direct transmission.

42. A method of communication in a wireless network as set forth in claim 40, wherein instantaneous RD link power levels are used in order to differentiate ACO timers in the second ACO epoch from those in the previous ACO epoch.

43. A method of communication in a wireless network as set forth in claim 40, wherein in order to differentiate ACO timers in the second ACO epoch from those in the previous ACO epoch, the relay nodes assign a new timer based on random values such that the relay node generates a random number, calculates the duration for random number of ACO slots, and adds this duration to its previous timer value.

44. A method of communication in a wireless network as set forth in claim 1, wherein the relay nodes that will not cooperate in cooperative data transmission stage set their NAV timers to go to a sleep state, which lasts for the Network Allocation Vector duration.

45. A method of communication in a wireless network as set forth in claim 44, wherein a relay node goes to sleep state depending on the scheme of transmission being direct or cooperative and whether it is a candidate relay node or not for cooperative transmission.

46. A method of communication in a wireless network as set forth in claim 30, wherein the relay nodes that will not cooperate in cooperative data transmission stage set their NAV timers to go to a sleep state, which lasts for the Network Allocation Vector duration, and a relay node goes to sleep state depending on the scheme of transmission being direct or cooperative and whether it is a candidate relay node or not for cooperative transmission, and wherein a relay node goes to sleep state if it infers that cooperative transmission is intended and it is not a candidate for cooperative transmission, it then sets its Network Allocation Vector timer so that it does not access medium till the end of the ACO epoch.

47. A method of communication in a wireless network as set forth in claim 36, wherein the relay nodes that will not cooperate in cooperative data transmission stage set their NAV timers to go to a sleep state, which lasts for the Network Allocation Vector duration, and a relay node goes to sleep state depending on the scheme of transmission being direct or cooperative and whether it is a candidate relay node or not for cooperative transmission, and wherein a candidate relay node goes to sleep state if it decides that that, upon receiving an ACO packet from a candidate relay node and upon reconsidering its own cooperation decision, it is no longer a candidate relay for cooperative transmission, then it sets its NAV timer until the end of the ACO epoch and goes to sleep.

48. A method of communication in a wireless network as set forth in claim 40, wherein the relay nodes that will not cooperate in cooperative data transmission stage set their NAV timers to go to a sleep state, which lasts for the Network Allocation Vector duration, and a relay node goes to sleep state depending on the scheme of transmission being direct or cooperative and whether it is a candidate relay node or not for cooperative transmission, and wherein a relay node goes to sleep state if it infers that cooperative transmission is intended and it is not a candidate for cooperative transmission, it then sets its Network Allocation Vector timer so that it does not access medium till the end of the ACO epoch, and wherein when said NAV timer expires at the end of the ACO epoch, if the source node decides that the existing cooperation set can be successful without an ACO collision, a new NAV timer is set so that said relay node remains in sleep state until the end of phase 1 and phase 2 transmissions or it infers that direct transmission is intended, it remains in sleep state during the same.

49. A method of communication in a wireless network as set forth in claim 40, wherein the relay nodes that will not cooperate in cooperative data transmission stage set their NAV timers to go to a sleep state, which lasts for the Network Allocation Vector duration, and a relay node goes to sleep state depending on the scheme of transmission being direct or cooperative and whether it is a candidate relay node or not for cooperative transmission, and wherein a candidate relay node goes to sleep state if it decides that that, upon receiving an ACO packet from a candidate relay node and upon reconsidering its own cooperation decision, it is no longer a candidate relay for cooperative transmission, then it sets its NAV timer until the end of the ACO epoch and goes to sleep, and wherein when said NAV timer expires at the end of the ACO epoch, if the source node decides that the existing cooperation set can be successful without an ACO collision, a new NAV timer is set so that said relay node remains in sleep state until the end of phase 1 and phase 2 transmissions or it infers that direct transmission is intended, it remains in sleep state during the same.

50. A wireless system with a source node, a destination node and a plurality of relay nodes characterized in that selection of at least one relay node that minimizes total energy consumption to send one successful bit to destination node, under reliability condition expressed in terms of average BER level is performed according to the method claim 1 in the manner that the source node starts a transmission by sending a data packet, the relay nodes receiving a copy of this packet and the source node and the nodes in the cooperation set cooperatively transmitting the data packet to the destination node over orthogonal channels.
